(19) United States
(12) Patent Application Publication
(10) Pub. No.: US 2026/0064097 A1
(43) Pub. Date: Mar. 5, 2026

(54) METHOD AND SYSTEM FOR CONFIGURING A USER INTERFACE (UI) FOR A USER OF A BUILDING MANAGEMENT SYSTEM

(71) Applicant: Siemens Industry, Inc., Alpharetta, GA (US)

(72) Inventor: Nellie Martin, Libertyville, IL (US)

(73) Assignee: Siemens Industry, Inc., Alpharetta, GA (US)

(21) Appl. No.: 18/819,381

(22) Filed: Aug. 29, 2024

(51) Int. Cl. G05B 19/042

(52) U.S. Cl. CPC G05B 19/042; G05B 2219/25011

(57) ABSTRACT

A method for automatically configuring a user interface (UI) for a user of a building management system includes providing a plurality of UI templates and storing, by a memory, a plurality of datapoints generated by the building management system. Each UI template of the plurality of UI templates is linked to at least one type of data. Each datapoint of the plurality of datapoints generated by the building management system corresponds to a respective one of the types of data. The method includes identifying, by a processor, a role associated with the user, identifying, by the processor, a subset of UI templates of the plurality of UI templates based on the identified role associated with the user, and displaying, by a display, the identified subset of UI templates as the UI and the datapoints linked to the identified subset of UI templates, respectively.

### BACKGROUND

A building management system (BMS) controls a number of components (e.g., controllers and sensors) for heating, ventilation, and cooling (HVAC), electrical metering, safety, and/or other operations. These components are interconnected and controlled. The controllers and sensors, for example, generate a large amount of data (e.g., time series data) about operation of the different components. Where multiple buildings are involved, even more data is generated.

BMS workstations and remote applications that are integrated with such BMS workstations may have user interfaces (UIs) (e.g., BMS interfaces) that require manual configuration to customize the UI for a particular facility or building. Such manual configuration of the UI may be performed by a technician or an engineer based on preferences of an owner of the facility or building for data points to be monitored or controlled in the facility or building.

### SUMMARY

Employees of an enterprise that operates at the facility or building may not be consulted as to configuration of such BMS interfaces. Accordingly, conventional BMS interfaces may not be suited for or customized to employees of the enterprise, such as, for example, doctors or nurses at a hospital.

In order to provide a custom view of building data for a user based on a role of the user as an employee of an enterprise, a processor identifies a role of the user based on user identification data generated at a building management system workstation. The processor identifies a subset of UI templates of a plurality of UI templates based on the identified role of the user. The plurality of UI templates are stored in a database, and each UI template of the plurality of UI templates is linked to at least one type of data. The database also stores a plurality of datapoints generated by the building management system. Each datapoint of the plurality of datapoints generated by the building management system corresponds to a respective one of the types of data and is linked to at least one UI template of the plurality of UI templates. A display at the building management system workstation displays the identified subset of UI templates as the custom view of building data (e.g., a UI) and the datapoints linked to the identified subset of UI templates, respectively.

In a first aspect, a method for automatically configuring a user interface (UI) for a user of a building management system of an enterprise includes providing a plurality of UI templates. Each UI template of the plurality of UI templates being linked to at least one type of data. The method includes storing, by a memory, a plurality of datapoints generated by the building management system. Each datapoint of the plurality of datapoints generated by the building management system corresponds to a respective one of the types of data and is linked to at least one UI template of the plurality of UI templates. The method includes receiving, by a processor, user identification data for the user and identifying, by the processor, a role associated with the user based on the received user identification data. The role is specific to a function of the enterprise. The method includes identifying, by the processor, a subset of UI templates of the plurality of UI templates based on the identified role associated with the user. The method includes displaying, by a display, the identified subset of UI templates as the UI and the datapoints linked to the identified subset of UI templates, respectively.

In a second aspect, a system for automatic configuration of a user interface (UI) for a user of a building management system for an enterprise includes a database including a plurality of UI templates. Each UI template of the plurality of UI templates is linked to at least one type of data. The database also includes a plurality of datapoints generated by the building management system. Each datapoint of the plurality of datapoints is generated by the building management system corresponding to a respective one of the types of data and is linked to at least one UI template of the plurality of UI templates. The system includes a processor in communication with the database. The processor is configured to identify a role associated with the user. The role is specific to a function of the enterprise. The processor is also configured to identify a subset of UI templates of the plurality of UI templates based on the identified role associated with the user. The system includes a display in communication with the processor. The display is configured to display the identified subset of UI templates as the UI and the datapoints linked to the identified subset of UI templates, respectively.

In a third aspect, a method for automatically configuring a user interface (UI) displayed at a workstation of a building management system for different users of the workstation of the building management system includes providing a plurality of UI templates. Each UI template of the plurality of UI templates is linked to at least one type of data. The method includes storing, by a memory, a plurality of datapoints generated by the building management system. Each datapoint of the plurality of datapoints generated by the building management system corresponds to a respective one of the types of data and is linked to at least one UI template of the plurality of UI templates. The method includes identifying, by a processor, a first role associated with a first user at the workstation of the building management system. The first role is specific to a function of an enterprise for which the building management system is operated. The method includes identifying, by the processor, a first subset of UI templates of the plurality of UI templates based on the identified first role associated with the first user, and displaying, by a display, the identified first subset of UI templates as the UI and the datapoints linked to the identified first subset of UI templates, respectively. The method includes identifying, by the processor, a second role associated with a second user at the workstation of the building management system, the second user being different than the first user and the second role being different than the first role, identifying, by the processor, a second subset of UI templates of the plurality of UI templates based on the identified second role associated with the second user, the second subset of UI templates being different than the first subset of UI templates, and reconfiguring the UI, the reconfiguring of the UI comprising displaying, by the display, the identified second subset of UI templates as the UI and the datapoints linked to the identified second subset of UI templates, respectively.

Any one or more of the aspects or concepts summarized above or in the Illustrative Embodiments below may be used alone or in combination. The aspects or concepts described for one Illustrative Embodiment or aspect may be used in other embodiments or aspects. The aspects or concepts described for a method or system may be used in others of a system, method, or non-transitory computer readable storage medium.

These and other aspects, features, embodiments, and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The examples of the invention described below can be better understood with reference to the following figures. The components in the figures are not necessarily to scale, emphasis instead being placed upon illustrating the principles of the invention. In the figures, like reference numerals designate corresponding parts throughout the different views.

FIG. 1 shows one embodiment of a system for automatically configuring a user interface (UI) for a user of a building management system;

FIG. 2 shows one embodiment of a computer system for use with the system of FIG. 1;

FIG. 3 shows a flowchart of one embodiment of a method for automatically configuring a UI for a user of a building management system; and

FIG. 4 shows an example of a graphical user interface (GUI) configured for a user with a particular role.

### DETAILED DESCRIPTION

There are known approaches for obtaining data points associated with building devices monitored and controlled by a building management system. These known approaches, however, do not provide a custom view of building data for a user based on a role of the user as an employee of a building tenant (e.g., an enterprise). UI information for a user as a tenant instead of a building engineer or technician is provided by and/or on the building automation management system. Access to the building automation is open to the daily users using a template system.

In the present embodiments, user interface framework with application programming interface (API) is provided to interface with one or more cloud management applications and building management system data (e.g., data points of building devices currently monitored/controlled) associated with one or more buildings and tenants of (e.g., the enterprise at) the one or more buildings. As part of the commissioning process for a building, system architecture relevant to implementation of a building interface framework service is generated for a customer subscribing to the service.

Onboarding logic (e.g., a building management platform) for the subscribing customer provides the customer with the option to subscribe to various services (e.g., provided by the one or more cloud management applications). After subscribing, the onboarding logic sets up an account and a partition for the customer. A database of the building management system stores the building management system data, and the building management system data is pushed to or connected to the building management platform (e.g., the onboarding logic).

A user (e.g., an employee of the enterprise) interacts with the building management platform (e.g., the one or more cloud management applications) via, for example, a workstation at the one or more buildings. The user submits user identification data (e.g., username and/or password) at the workstation, and a landing page is displayed to the user at the workstation. The landing page is a personalized page for each unique user. The landing page (e.g., a dashboard) displays information that is pertinent to a role of the user within an organization (e.g., the enterprise). For example, a nurse at a hospital (e.g., the enterprise) has the role of nurse.

The dashboard includes multiple data panels dynamically created based on templates, and semantically enhanced data. For example, the landing page may be divided into sections (e.g., my dashboards, dashboard insights, building insights, recommendations). Patterns may be identified within the dashboard insights over time.

A portfolio of dashboards is generated for a plurality of roles, respectively, with each role of the plurality of roles corresponding to one or more users (e.g., employees) at the enterprise. Each dashboard of the portfolio of dashboards includes a subset of user interface (UI) templates. The subset of UI templates is based on the role of the user (e.g., surgeon, nurse, patient within a hospital; other roles within another vertical market or enterprise).

The dashboard (e.g., the subset of UI templates) includes content that is important to the user in the particular role. The dashboard for a particular role (e.g., UI templates of the respective subset) may originally be defined by analyzing custom generated dashboards for users with the particular role and determining overlap (e.g., intersection) of UI templates between the custom generated dashboards. In other words, historical data may be used to identify frequently used UI templates (e.g., for a predetermined percentage of users with the particular role) for a particular role, and the frequently used UI templates may be included in the dashboard for the particular role. The building management platform may thus be able to extract landing page information to new customers automatically by analyzing what existing customers are using, and include knowledge of the new customer.

The dashboard may be customized based on the identified vertical market. For example, the building management platform may recommend, to the user, monitoring of additional data points needed for specific data services applicable to the role of the user and/or the vertical market of the customer (e.g., critical space monitoring such as surgery rooms for hospital customers). Data panels of the dashboard may be created and/or modified based on an identified use case and/or the vertical market.

In the present embodiments, a plurality of UI templates are stored in a database (e.g., in the Cloud; formed by one or more databases). Each UI template of the plurality of UI templates is linked to at least one type of data. The types of data correspond to a particular enterprise and/or particular controllers and/or equipment of one or more buildings of the particular enterprise. For example, the types of data may include temperature within a particular room of the one or more buildings, pressure within a particular room of the one or more buildings, fan speed for a particular fan for a building of the one or more buildings, and/or other types of data.

The building management system is a control system configured to monitor and/or control controllers and/or equipment (e.g., mechanical, electrical, and/or electromechanical equipment) within the one or more buildings of the enterprise. The controllers and/or the equipment of the one or more buildings generates data (e.g., temperature data, pressure data, fan speed data) and transmits the generated data to the building management system (e.g., a memory or database of the building management system). The building management system transmits the generated data to the database in the Cloud, for example, where the generated data is stored. The generated data stored at the database in the Cloud includes a plurality of datapoints representing measurements of the controllers and/or the equipment of the one or more buildings at different time points, respectively.

The building management system and/or a processor in the Cloud may process the generated data. For example, the building management system and/or the processor in the Cloud may semantically enhance or tag the generated data, such that generated data is associated with the types of data, respectively, and is linked to the plurality of UI templates, respectively.

A workstation of the one or more buildings (e.g., of the building management system) receives user identification data for a user of the workstation. For example, the workstation includes one or more input devices (e.g., a keyboard and/or a mouse), and the workstation receives the user identification data via user input at the one or more input devices of the workstation. Any number of different types of user identification data may be received at the workstation. For example, the user identification data may include a username and/or a password corresponding to the user.

The workstation may transmit the user identification data to a processor (e.g., a processor in the Cloud running an application of a building management platform or another enterprise application or software) via a network (e.g., a wireless network). The processor in the Cloud, for example, may identify a role associated with the user based on the user identification data. For example, the database may store a permission matrix (e.g., as a table) that defines roles for each user (e.g., employee) of a plurality of users at the enterprise. For example, the permission matrix may list usernames and corresponding roles for the plurality of users, respectively (e.g., a row corresponds to a particular user and lists at least a username and a role for the particular user). The processor may compare at least some of the user identification data (e.g., the username) with the permission matrix, and when, based on the comparison, there is a match between the username, for example, and an entry in the permission matrix, identify the role that corresponds to the user.

The user is a tenant working in the environment (e.g., room, hallway, floor, or building) controlled by the building automation system. The user as a tenant may be different than a building engineer or technician whose role is to monitor, arrange, program, and/or fix the building automation system for other tenants.

The processor in the Cloud, for example, may also identify a subset of UI templates of the plurality of UI templates stored in the database based on the user identification data. The subset of UI templates may be UI templates associated with the user and, more specifically, the role of the user. For example, the permission matrix may also identify a subset of UI templates of the plurality of UI templates (e.g., representations of the respective subset of UI templates) for each user of the plurality of users. For example, in addition to the usernames and corresponding roles for the plurality of users, respectively, the permission matrix may also identify subsets of UI templates to be displayed to the user, respectively (e.g., a row corresponds to a particular user and lists at least a username, a role for the particular user, and representations of UI templates to be displayed). In one embodiment, the database in the Cloud stores another permission matrix that defines (e.g., within a table) subsets of UI templates (e.g., representations for UI templates of the respective subset) for the roles within, for example, the enterprise, respectively. The processor may compare at least some of the user identification data (e.g., the username) with the permission matrix, or the identified role with the other permission matrix, and when, based on the comparison, there is a match, identify the subset of UI templates that correspond to the user (e.g., the role of the user).

The processor in the Cloud (e.g., the processor in the Cloud running the application of the building management platform) may transmit (e.g., via the wireless network) data for the identified subset of UI templates and the linked datapoints to the workstation of the building management system, and a display of the workstation may display a UI including the subset of UI templates and the linked datapoints.

The automatically generated user-specific UI of the present embodiments displays relevant data generated by a building management system to a user with a particular role within an enterprise without time-consuming customization of the UI by the user being necessary. For example, the present embodiments decrease time to commission or configure a building management system user interface for a user having a role that is not a technician or facility administrator.

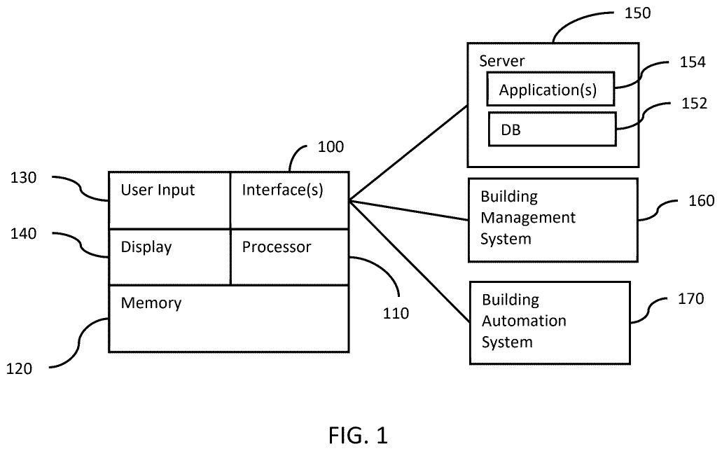

FIG. 1 shows a building control system. The building control system may form a building automation system or include a building automation system. The building control system controls a building automation system 170.

The building control system includes an interface or interfaces 100, a processor 110, a memory 120, a user input 130, and a display 140. The interface 100, the display 140, the processor 110, the user input 130, and/or the memory 120 may be part of a computer, a server, a workstation, or another system, such as the building automation system 170 or a building management system 160. In one embodiment, the building control system includes a plurality of workstations or computers within one or more buildings of an enterprise. Each workstation or computer of the plurality of workstations includes at least an interface or interfaces 100, a processor 110, a memory 120, a user input 130, and a display 140. For example, a nurse or doctor has access to a computer, which is used for various purposes. The computer may provide access to the building control system, such as the processor 110 being the processor of the computer.

The building control system may further include a server 150 connected to the interfaces 100 through a computer network. The server 150 hosts a database 152 and one or more applications 154 (e.g., including Internet of things (IoT) applications). The server 150 is, for example, a cloud server or represents a plurality of cloud servers (e.g., for serverless computing). In other embodiments, the database 152 is hosted locally to the processor 110, such as where the processor 110 is part of a server or where the database 152 is implemented on a computer of a manager of the building automation system 170. In other implementations, the processor 110 is part of the building automation system 170, whether local or remote from the building. In yet another implementation, the processor 110 is part of the building management system 160, whether local or remote from the building.

Users (e.g., workers at an enterprise) may use the plurality of workstations to receive and/or generate data and transmit the data to the server 150. Each workstation of the plurality of workstations and the server 150 may be located in the same or different rooms, the same or different facilities, or the same or different enterprise campuses. The plurality of workstations may be operated in one or more first geographic locations, and the server 150 may be operated in a second geographic location that is remote from the first geographic location.

The building control system may include more databases 152 within the server 150 or separate from the server 150. The database 152 includes a plurality of datasets. Each dataset of the plurality of datasets may include, for example, datapoints generated by the building management system 160, source code, a computer program representing an application, a set of subroutine definitions, communication protocols, tools representing an API, a data model, one or more computer system configurations, or any combination thereof.

Additional, different, or fewer components may be provided. For example, a computer network is included for use of the applications 154 based on locally entered input and output results. As another example, additional building automation systems 170 are provided, such as where the processor 110 and/or server 150 are used for a service provided to different building automation systems or a building automation system for multiple buildings. In another example, the building automation system 170, the building management system 160, and/or the server 150 are not provided.

The building automation system 170 includes heating ventilation air conditioning (HVAC), fire safety, security, and/or other automated components for operating one or more buildings of an enterprise. The building automation system 170 may be for one building, one floor, multiple floors of a building, multiple buildings, a facility, and/or a complex. The building automation system 170 may include panels, controllers, sensors, user inputs, actuators, alarms, ducts, heaters, fans, air conditioners, filters, boilers, heat exchangers, supervisor computers, and/or other components. The components are communicatively connected so that the building automation system 170 may be monitored, altered, and/or otherwise controlled.

The building management system 160 may be a computer that is part of or separate from the building automation system 170. The building management system 160 may be implemented on a panel or another processor, whether remote or local to the building automation system 170. The building management system 160 communicates over a computer network with the components of the building automation system 160, such as communicating with panels of the building automation system 160. The building management system 160 may receive time series data indicating the operation of the various components of the building automation system 170. In one embodiment, the building management system 160 may forward the received time series data indicating the operation of the various components of the building automation system 170 to the server 150 (e.g., the database 152 of the server 150). Other information, such as user interface (UI) templates, tickets, or user comments, may be provided to or stored at the building management system 160.

The building management system 160 executes a program for controlling the building automation system 170. A user interface (UI) for reviewing operation and data from the building automation system 170 and/or for changing operation of components of the building automation system 170 may be provided. The UI for reviewing operation and data from the building automation system 170 and/or for changing operation of components of the building automation system 170 may be displayed at the display 140 of the building control system. In one implementation, the processor 110 is part of the building management system 160.

The building management system 160 is configured by program code to generate a list of faults in operation of the building automation system 170 and to generate statistics for the operation of the building automation system 170. In alternative implementations, the statistics are created by another computer, so the building management system 160 generates the statistics by receipt and adding to a prompt.

The interface 100 is shown as one interface, but multiple interfaces may be provided. The interface 100 is a modem, a computer network interface, an ethernet interface, Wi-Fi, Bluetooth, and/or other computer networking interface for receiving and/or transmitting communications.

The interface 100 is configured by a specification or standard design, controller, and/or by the processor 110. The interface 100 is configured to receive information from the building automation system 170, the building management system 160, and/or the server 150. The interface 100 is also configured to transmit information from the building automation system 170 and/or the building management system 160 to the server 150.

The processor 110 is a control processor, a general processor, a digital signal processor, a graphics processing unit, an application specific integrated circuit, a field programmable gate array, an artificial intelligence processor or accelerator, a digital circuit, an analog circuit, combinations thereof, or another now known or later developed device for, for example, generating a UI. The processor 110 is part of the server 150, the building management system 160, the building automaton system 170, or a stand-alone computer, server, or workstation. The processor 110 is a single device, a plurality of devices, or a network. For more than one device, parallel or sequential division of processing may be used. Different devices making up the processor 110 may perform different functions or the same function in parallel. The processor 110 operates pursuant to stored instructions, hardware, and/or firmware to perform various acts described herein.

The memory 120 is configured by formatting and/or the processor 110 to store information for monitoring the building automation system 170. For example, the memory 120 stores a plurality of UI templates.

The memory 120 is an external storage device, RAM, ROM, database, and/or a local memory (e.g., solid state drive or hard drive). The same or different non-transitory computer readable media may be used for the instructions and other data. The memory 120 may store instructions for operating the processor 110 and/or the server 150. The memory 120 may be implemented using a database management system (DBMS) and/or be a hard disk, RAM, or removable media. Alternatively, the memory 120 is internal to the processor 110 (e.g., cache). The memory 120 is formed from one device or a collection of devices, such as different memories storing different types of data.

Instructions for generating UI templates, identifying a role associated with a user, identifying a subset of the UI templates, and displaying the identified subset of UI templates by the processor 110 are provided on non-transitory computer-readable storage media or memories, such as a cache, buffer, RAM, removable media, hard drive or other computer readable storage media (e.g., the memory 120). Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination.

In one embodiment, the instructions are stored on a removable media device for reading by local or remote systems. In other embodiments, the instructions are stored in a remote location for transfer through a computer network. In yet other embodiments, the instructions are stored within a given computer, CPU, GPU, or system. Because some of the constituent system components and method steps depicted in the accompanying figures may be implemented in software, the actual connections between the system components (or the process steps) may differ depending upon the way the present embodiments are programmed.

The server 150 is a computer, workstation, graphics processing unit, tensor processor, artificial intelligence processor, and/or server card. The server 150 is configured by hardware, firmware, and/or software to implement one or more applications stored at the server 150. Alternatively, the processor 110 implements the one or more applications.

The user input 130 is a keyboard, buttons, sliders, dials, trackball, mouse, touch pad, touch screen, microphone, and/or another device for user interaction with the processor 110 and/or building control system. The user input 130 is part of a graphics user interface for receiving user input, such as setpoint control. The user input 130 may be configured by the processor 110 and/or hardware to receive inputs for interaction of the user with applications stored at the server 150.

The display 140 is a CRT, LCD, projector, plasma, printer, tablet, smart phone, or another now known or later developed display device for displaying the UI, monitored data, and/or other information. The display 140 is configured by loading an image to a display buffer or plane, and the image is then displayed on a screen. Other configuration may be provided, such as configuring for display by printing.

In other implementations, the building control system includes multiple building automation systems 170, or the building automation system 170 is for multiple buildings. The building management system 160 connects with the multiple buildings or building automation systems 170. The processor 110 is a server, workstation, or computer configured to generate and display UIs for multiple users of the server, workstation, or computer.

A UI (e.g., a graphical user interface (GUI)) displayed at the display 140 of the workstation may be automatically configured for a user of the workstation, such that information relevant to the user is displayed to the user without time-consuming customization of the UI being necessary. The database 152 of the server 150 stores a plurality of UI templates, via which a user may view and/or control a parameter within one or more buildings controlled by the building management system 160.

Each UI template of the plurality of UI templates is linked to at least one type of data (e.g., at least one parameter controlled by the building management system 160) and may be any number of different shapes and/or sizes. For example, a first UI template of the plurality of UI templates may be a UI panel of a first predetermined size (e.g., two inches by two inches square) that is linked to and displays a temperature within a first room of a first building of an enterprise. A second UI template of the plurality of UI templates may be a UI panel of the first predetermined size that is linked to and displays a temperature within a second room of the first building of the enterprise. A third UI template of the plurality of UI templates may be a UI panel of the first predetermined size that is linked to and displays a temperature within a first room of a second building of the enterprise. A fourth UI template of the plurality of UI templates may be a UI panel of a second predetermined size (e.g., four inches by two inches rectangle) that is linked to and displays a fan speed for a fan associated with the first room of the first building.

Any template may be linked to and display multiple parameters, such as temperatures and/or fan speeds for one or multiple rooms. Any building automation parameters may be available, depending on the role or job of the user. Some example parameters include temperature, fan speed, humidity, flow, pressure, status, and/or setpoints thereof.

The plurality of UI templates stored at the database 152 may include more, fewer, and/or different UI templates. For example, the plurality of UI templates may include UI templates for the display and control of fan speed, valve opening, pressure, other parameters, or any combination thereof.

The building management system 160 may receive time series data (e.g., of different data types corresponding to parameters within the one or more buildings) indicating the operation of the various components of the building automation system 170. The building management system 160 may forward the received time series data indicating the operation of the various components of the building automation system 170 to the server 150, and the time series data may be stored in the database 152 of the server 150. A processor (e.g., the processor 110 or a processor of the server 150) may process (e.g., semantically enhance or tag) the time series data, such that the time series data may be linked to the plurality of UI templates, respectively. For example, the processor may identify a first datapoint of the time series data as being a measured temperature within the first room of the first building and tag the first datapoint as such. The first UI template may thus be linked with the first datapoint (e.g., and any other datapoints of the time series data identified as being a measured temperature within the first room of the first building).

The user may request display of the UI at the workstation (e.g., by logging into a web interface at the workstation). The processor of the server 150 determines a source of the request. When generating the request, the workstation, for example, may include requestor identification information within the request. Alternatively, the first computing device workstation, for example, may transmit the requestor identification information to the server 150 separately from the request. In one embodiment, the user, for example, enters login data (e.g., a username and a password) to display the UI, and the workstation, for example, transmits at least some of the login data to the server 150, such that the server 150 may determine the source of the request based on the login data. The server 150 may identify the source of the request in other ways.

The processor of the server 150 may compare the determined source of the request to the authorization data stored at the database 152, for example. The authorization data may identify users of the enterprise that are authorized to interact with the building management system 160, for example. In other words, the server 150 determines whether the source of the request (e.g., the user) is authorized to view and/or control parameters of the one or more buildings, controlled by the building management system 160. Based on the comparison, the server 104 may determine whether the determined source of the request matches the authorization data.

In one embodiment, a memory of the server 150 (e.g., the database 152) or a memory in communication with the server 150 stores a permission matrix that defines which sources of requests (e.g., users, computing devices, and/or enterprises) are authorized to view and/or control which data generated by the building management system 160. Further, the permission matrix may define roles for a plurality of users (e.g., employees of the enterprise).

The permission matrix may be, for example, a tabular dataset that defines each user (e.g., identified by a login), computing device (e.g., identified by an IP address), and/or enterprise (e.g., identified by a number of IP addresses or a login) that is able to view data generated by and/or control parameters controlled by the building management system 160. In one embodiment, the permission matrix also defines which types of data generated and/or controlled by the building management system 160, for example, each of the users is able to view and/or control. For example, the permission matrix may define which UI templates of the plurality of UI templates are to be initially displayed to a particular user and which UI templates of the plurality of UI templates may be displayed to the particular user. For example, the permission matrix may define, for a first user, that the first UI template and the second UI template are to be displayed to the first user upon login, the third UI template may be displayed to the first user after login (e.g., in response to a customization request), but the fourth UI template may not be displayed to the first user.

Permissions within the permission matrix may be defined by one or more users at the enterprise, one or more users at another enterprise, other users at other enterprises, respectively, and/or individual developers. For example, a user that is an individual developer may transmit data indicating the user is to view the first UI template and the second UI template at login (e.g., a first permission), and another user at the enterprise may transmit data indicating the user is allowed to request the third UI template for display (e.g., a second permission). The processor of the server 150 may edit the permission matrix to include the first permission and/or the second permission. The permission matrix may be updated as, for example, more users are added (e.g., more employees are hired at the enterprise), more or fewer buildings are controlled by the building management system 160, new roles are added to the enterprise, and/or new equipment is added or old equipment is removed from the one or buildings of the enterprise.

In one embodiment, the permission matrix is formed by a first permission matrix and a second permission matrix. The memory of the server 150 (e.g., the database 152) or a memory in communication with the server 150 stores the first permission matrix and the second permission matrix. The second permission matrix defines which UI templates of the plurality of UI templates are to be displayed for particular roles within the enterprise, respectively. In other words, the fist permission matrix defines which users of the plurality of users may access any data of the building management system 160 and defines a role for each user of the plurality of users, and the second permission matrix defines which UI templates of the plurality of UI templates are to be displayed to the users with a particular role. In one embodiment, the first permission matrix and the second permission matrix are editable by different users and/or developers.

The server 150 may receive the user identification data and may determine a role associated with the user based on the received user identification data. For example, the server 150 may compare at least some of the user identification data (e.g., the username) to the permission matrix and, based on the comparison, determine the role associated with the user. For example, if the username matches a username within the permission matrix, the server 150 may identify the role corresponding to the matched username within the permission matrix. In one embodiment, the server 150 compares the username, for example, to the first permission matrix and, based on the comparison, determines the role associated with the user.

The server 150 identifies a subset of UI templates of the plurality of UI templates based on the identified role associated with the user. For example, the server 150 determines which UI templates of the plurality of UI templates are to be displayed to the user based on the data stored in the permission matrix (e.g., data identifying the UI templates to be displayed). In one embodiment, the server 150 identifies the role for the user within the first permission matrix, and then identifies the UI templates to be displayed within the second permission matrix. For example, for the first user, the server 150 may identify that the first UI template and the second UI template are to be displayed to the first user upon login.

The server 150 may transmit data for the identified subset of UI templates to the workstation, and the workstation may process the transmitted data and display the identified subset of UI templates to the user as the UI at the display. In one embodiment, the plurality of UI templates are stored locally at the workstation, and the server 150 transmits data identifying the subset of UI templates. The workstation may then generate the UI including the subset of UI templates stored at the workstation.

The server 150 may also transmit the linked datapoints of the time series data, such that the UI displays the linked datapoints within the subset of UI templates of the UI, respectively. In one embodiment, the linked datapoints of the time series data are stored locally at the workstation, and the UI displays the locally stored linked datapoints within the subset of UI templates.

The user may control parameters at one or more buildings of the enterprise using the displayed subset of UI templates. For example, the user may control the temperature within the first room of the first building within the first UI template displayed within the UI, and may control the temperature within the second room of the first building within the second UI template displayed within the UI.

The user, at an input device of the workstation, for example, may request one or more additional UI templates (e.g., an additional UI template) of the plurality of UI templates to be displayed with the subset of UI templates. For example, the first user may login at the workstation, and the first UI template and the second UI template may be automatically displayed at the display of the workstation based on the role assigned to the first user. The first user, via the input device of the workstation, may request display of the third UI template. The request may be transmitted to the server 150 (e.g., via the network), and the server 150 may determine whether the first user is allowed to view data associated with the third UI template. For example, the server 150 may determine whether the first user is allowed to view data associated with the third UI template based on data within the permission matrix corresponding to the user (e.g., the username for the user). If, based on the determination, the first user is allowed to via the data associated with the third UI template, the server 150 may transmit data for the third UI template, and corresponding linked time series data, for example, to the workstation for display to the user as part of the subset of UI templates or separate from the subset of UI templates.

The building control system, for example, may track the number of users with a particular role (e.g., nurse) of the plurality of users that request the additional UI template (e.g., the third UI template). For example, the building control system may determine a number of the users or a percentage of users with the particular role that have requested the additional UI template. When the determined number of users or the determined percentage of users is greater than a predetermined threshold number of users or a predetermined threshold percentage, respectively, the building control system may transmit a request to add the additional UI template to the subset of UI templates (e.g., as defined within the permission matrix) for all users with the particular role. In one embodiment, the building control system transmits the tracked number of user to the server 150, and the server 150 determines when to change the permission matrix to include the additional UI template within the subset of UI templates for all users with the particular role (e.g., when the determined number of users or the determined percentage of users is greater than the predetermined threshold number of users or the predetermined threshold percentage, respectively).

As an example, the enterprise (e.g., a hospital) may include fifty nurses (e.g., users of the plurality of users with the role of nurse), and the building control system may track how many of the nurses request (e.g., via a workstation of the plurality of workstations) the third UI template to be included within the automatically generated UI (e.g., to be included within the subset of UI templates displayed together or within a separate tab of the UI). Once a predetermined number of nurses (e.g., thirty nurses) or a predetermined percentage of the nurses at the hospital (e.g., 70% of the fifty nurses) request the third UI template be included within the automatically generated UI, the building control system generates a request to include the third UI template within the subset of UI templates for automatic display at the respective workstation, and transmits the request to the server 150, for example. In one embodiment, the server 150, for example, tracks the requests and changes the subset of UI templates for a particular role when a threshold is met.

The enterprise may be any number of different enterprises including, for example, a hospital, a school, a pharmacy, or another type of enterprise. The enterprise may include employees with particular roles at the enterprise (e.g., roles with functions specific to the enterprise). For example, the hospital may include nurse supervisors, nurses, a head of surgery, surgeons, doctors, custodians, patients and/or other employees, and/or occupants with other roles at the enterprise. As another example, the school may include a campus administrator, principals, teachers, coaches, custodians, students, and/or other employees and/or occupants with other roles at the enterprise. As yet another example, the pharmacy may include managers, pharmacists, nurses, patients, and/or other employees and/or other occupants with other roles at the enterprise. The enterprise may also include one or more engineering technicians.

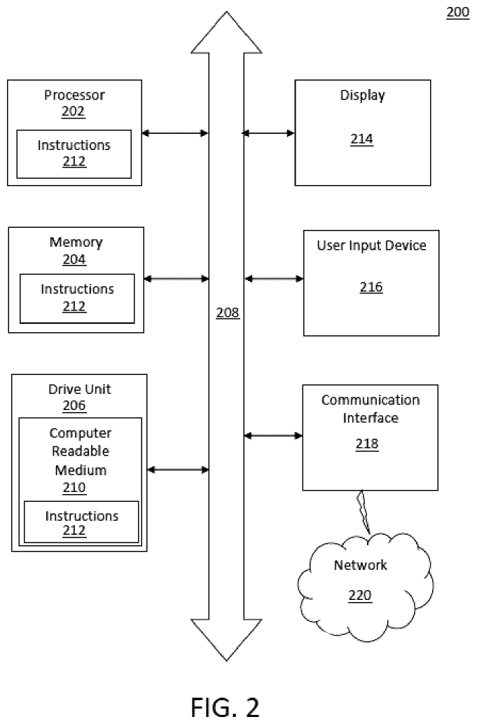

FIG. 2 shows an illustrative embodiment of a general computer system 200. The computer system 200 may include a set of instructions that may be executed to cause the computer system 200 to perform any one or more of the methods or computer-based functions disclosed herein. The computer system 200 may operate as a standalone device or may be connected (e.g., using a network) to other computer systems or peripheral devices. Any of the components discussed above (e.g., the building control system, the building automation system 170, or the building management system 160) may be a computer system 200 or a component in the computer system 200.

In a networked deployment, the computer system 200 may operate in the capacity of a server or as a client user computer in a client-server user network environment, or as a peer computer system in a peer-to-peer (or distributed) network environment. The computer system 200 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In one embodiment, the computer system 200 may be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202, e.g., a central processing unit (CPU), a graphics processing unit (GPU), or both. The processor 202 may be a component in a variety of systems. For example, the processor 202 may be part of a standard personal computer or a workstation. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The computer system 200 may include a memory 204 that may communicate via a bus 208. The memory 204 may be representative of the database 152. The memory 204 may be a main memory, a static memory, or a dynamic memory. The memory 204 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 204 includes a cache or random access memory for the processor 202. In alternative embodiments, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the programmed processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 200 may further include a display unit 214, such as a liquid crystal display (LCD), an organic light emitting diode (OLED), a flat panel display, a solid-state display, a cathode ray tube (CRT), a projector, a printer or other now known or later developed display device for outputting determined information. The display 214 may act as an interface for the user to see the functioning of the processor 202, or specifically as an interface with the software stored in the memory 204 or in a disk or optical drive unit 206 (e.g., a disk drive unit).

Additionally, the computer system 200 may include an input device 216 configured to allow a user to interact with any of the components of system 200. The input device 216 may be a number pad, a keyboard, or a cursor control device, such as a mouse, or a joystick, touch screen display, remote control or any other device operative to interact with the system 200.

In one embodiment, as depicted in FIG. 2, the computer system 200 may also include the disk or optical drive unit 206. The disk drive unit 206 may include a computer-readable medium 210, in which one or more sets of instructions 212 (e.g., software) may be embedded. Further, the instructions 212 may embody one or more of the methods or logic as described herein. In one embodiment, the instructions 212 may reside completely, or at least partially, within the memory 204 and/or within the processor 202 during execution by the computer system 200. The memory 204 and the processor 202 also may include computer-readable media as discussed above.

The present disclosure contemplates a non-transitory computer-readable medium that includes instructions 212 or receives and executes instructions 212 responsive to a propagated signal, so that a device connected to a network 220 may communicate voice, video, audio, images or any other data over the network 220. Further, the instructions 212 may be transmitted or received over the network 220 via a communication port 218. The communication port 218 may be a part of the processor 202 or may be a separate component. The communication port 218 may be created in software or may be a physical connection in hardware. The communication port 218 is configured to connect with the network 220 or another network, external media, the display 214, any other components in system 200, or combinations thereof. The connection with the network 220 may be a physical connection, such as a wired Ethernet connection or may be established wirelessly as discussed below. Likewise, the additional connections with other components of the system 200 may be physical connections or may be established wirelessly.

The network 220 may include wired networks, wireless networks, or combinations thereof, and may be representative of the network 106. The wireless network may be a cellular telephone network, an 802.11, 802.16, 802.20, or WiMax network. Further, the network 220 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media (e.g., a centralized or distributed database and/or associated caches and servers that store one or more sets of instructions). The term “computer-readable medium” shall also include any medium that is capable of storing, encoding or carrying a set of instructions for execution by a processor or that cause a computer system to perform any one or more of the methods or operations disclosed herein.

In a particular non-limiting, example embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In one embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an example, non-limiting embodiment, implementations may include distributed processing, component/object distributed processing, and parallel processing. Alternatively, virtual computer system processing may be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

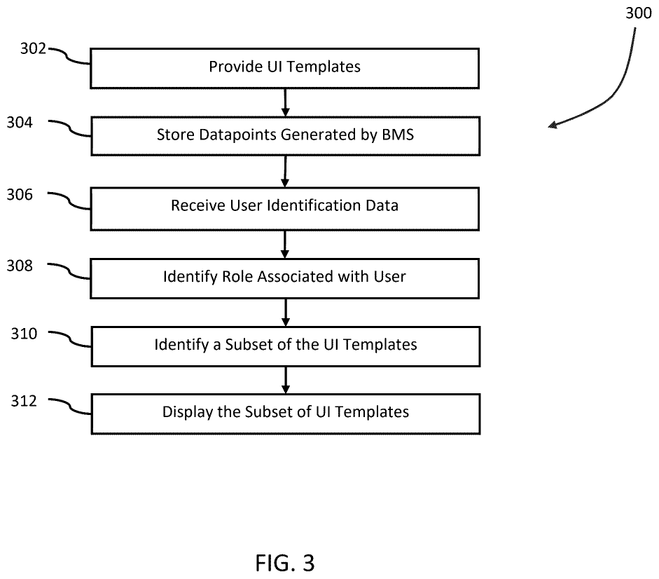

FIG. 3 shows a flowchart of one embodiment of a method 300 for automatically configuring a UI for a user of a building management system. The method 300 may be performed using the system 100 shown in FIG. 1, one or more of the computer systems 200 shown in FIG. 2, or another system. The method 300 is implemented in the order shown, but other orders may be used. Additional, different, or fewer acts may be provided. Similar methods may be used for presenting information relevant to user activity.

In act 302, a plurality of UI templates are provided. The plurality of UI templates may be provided in a database in communication with a building control system, a building automation system, and/or a building management system (e.g., a building management system). The building management system, for example, includes a plurality of workstations within one or more buildings of an enterprise, and the building management system controls controllers and/or equipment within the one or more buildings of the enterprise. A user of a plurality of users (e.g., employees) within the enterprise interacts with a workstation of the plurality of workstations to view data related to the controllers and/or the equipment, and/or to control parameters associated with the controllers and/or the equipment.

In one embodiment, the database is a database of a server remote from the building management system. For example, the server is a Cloud server. In another embodiment, the database is a database of the building management system (e.g., stored within a memory of one or more workstations of the plurality of workstations).

In act 304, a memory stores a plurality of datapoints generated by the building management system. The plurality of datapoints may be time series data for parameters associated with the controllers and/or equipment within the one or more buildings. For example, a first subset of datapoints of the plurality of datapoints may be time series data for a temperature measured by a first sensor within a first room of a first building of the one or more buildings. A second subset of datapoints of the plurality of datapoints may be time series data for a temperature measured by a second sensor within a second room of the first building. A third subset of datapoints of the plurality of datapoints may be time series data for a temperature measured by a third sensor within a first room of a second building of the one or more buildings. A fourth subset of datapoints of the plurality of datapoints may be time series data for a fan speed measured by a fourth sensor of a fan associated with the first room of the first building. The plurality of datapoints may include more, fewer, and/or different types of data associated with more, fewer, and/or different controllers and/or equipment of the one or more buildings.

The memory may be a memory of the remote server. For example, the controllers and/or the equipment of the building management system may generate the plurality of datapoints and transmit, via a network, the plurality of datapoints to the memory of the remote server for storage. In one embodiment, the memory is a memory of the building management system (e.g., a workstation of the plurality of workstations).

In act 306, a first processor receives user identification data for the user. For example, the user enters the identification data at the workstation, via one or more input devices of the workstation (e.g., a keyboard). The identification data may be any number of different types of user identification data including, for example, a username and/or a password. The first processor may be, for example, a processor of the workstation.

The first processor transmits (e.g., via the network) the received user identification data to, for example, the remote server. For example, the first processor may transmit the received username and password to the remote server to determine whether the user is an authorized user (e.g., is permitted to interact with the building management system) and/or to determine a UI to be automatically generated and displayed at the workstation.

In act 308, the first processor or a second processor (e.g., the second processor, remote from the first processor) identifies a role associated with the user based on the user identification data for the user. For example, the second processor is a processor of the remote server, and the second processor identifies the role associated with the user based on the user identification data for the user received at the workstation and transmitted to the remote server.

The memory of the remote server, for example, stores a permission matrix. The permission matrix identifies users (e.g., usernames) that are able to view data for and/or control parameters of the building management system. The permission matrix may also define roles for the users, respectively. For example, a number of roles (e.g., a nurse, a surgeon, a building engineer) may be defined for an enterprise (e.g., a hospital), and the permission matrix identifies one of the defined roles for each of the users listed within the permission matrix. The permission matrix may be generated by a developer at the commissioning of the building, when the enterprise moves into the building, and/or at other times. The permission matrix may be edited when new employees are hired at the enterprise and when employees leave the enterprise. The permission matrix may be edited by users with a particular role at the enterprise (e.g., a building engineer) or outside the enterprise (e.g., a developer).

The second processor may identify the role associated with the user by comparing the received identification data to the permission matrix. When, based on the comparison, the received identification data (e.g., the username) matches an entry within the permission matrix, the second processor identifies the role associated with, for example, the username within the permission matrix. In one embodiment, when, based on the comparison, the received identification data does not match any entries within the permission matrix, the display of the workstation may display a predetermined UI (e.g., including general data associated with the building management system, such as lists of buildings and/or rooms) or may not display any UI associated with the building management system.

In act 310, the first processor or the second processor (e.g., the second processor) identifies a subset of UI templates of the plurality of UI templates stored in the database based on the identified role associated with the user. For example, the permission matrix may also identify UI templates of the plurality of UI templates that form the subset of UI templates for the user. More specifically, the permission matrix may identify UI templates of the plurality of UI templates that form the subset of UI templates for the particular role assigned to the user. For example, the permission matrix may identify the first UI template (e.g., UI_template_1) and the second UI template (e.g., UI_template_2) as being included within the subset of UI templates for the first user.

In one embodiment, the permission matrix may be formed by a first permission matrix and a second permission matrix stored in, for example, the memory of the remote server. The first permission matrix may identify roles for each user of the plurality of users, and the second permission matrix may list (e.g., in tabular form) UI templates of the plurality of UI templates to be automatically displayed at login for each of the roles defined for the enterprise. Such a configuration may allow for easier adjustment (e.g., editing) of UI templates that form the subset for a particular role.

The permission matrix, through the definition of UI templates to be displayed for particular roles, may also identify types of data to be displayed to a user with a particular role. Further, the permission matrix may identify which types of data (e.g., which parameters) are changeable by the user. The types of data that are changeable by the user may be user-specific or role-specific. For example, a third user may have a same role as the first user (e.g., nurse), but the permission matrix may define different types of data (e.g., parameters) that are changeable by the first user and the third user, respectively. For example, the permission matrix may identify that the first user may change a temperature within the first room within the first building (e.g., via the first UI template) but may not change the temperature within the second room within the first building (e.g., via the second UI template), while the permission matrix may identify that the second user may change the temperature within the second room within the first building (e.g., via the second UI template) but may not change the temperature within the first room within the first building (e.g., via the first UI template). In other words, the first UI template and the second UI template may be automatically displayed to both the first user and the second user, but the permission matrix may define how the first user and the second user are able to interact with the first UI template and the second UI template differently.

In one embodiment, the permission matrix may also define ranges within which parameters that are controllable within the subset of UI interfaces, respectively, may be set. In one embodiment, the defined ranges may be included within the second permission matrix. In another embodiment, the defined ranges are stored separately from the permission matrix.

In act 312, the subset of UI templates identified in act 310 are displayed as the UI at the workstation. Datapoints of the plurality of datapoints linked to the subset of UI templates identified in act 310 may also be displayed with the subset of UI templates, respectively.

Different users (e.g., the first user and the second user) may enter different identification data at the workstation (e.g., different usernames entered via the input device of the workstation) at different times, and the UI at the display may have different configurations based on the roles associated with the different users, respectively. For example, the first user may enter a first username (e.g., corresponding to the first user) at the workstation, and the display at the workstation may automatically display a first UI formed by the first subset of UI templates, which correspond to the first role of the first user. At a later time, the second user may enter a second username (e.g., corresponding to the second user) at the workstation, and the display at the workstation may automatically display a second UI formed by the second subset of UI templates, which corresponds to the second role of the second user. In other words, a nurse may log into the workstation (e.g., or a web interface at the workstation), and the display of the workstation may automatically display a first UI formed by a first subset of UI panels via which data for a first group of parameters may be viewed and/or controlled. At a later time, a building engineer may log into the workstation (e.g., or a web interface at the workstation), and the display of the workstation may automatically display a second UI formed by a second subset of UI panels via which data for a second group of parameters may be viewed and/or controlled.

Depending on the roles of the different users, respectively, one user may be presented (e.g., via the display of the workstation) more UI templates (e.g., UI panels) than the other user. For example, the building engineer (e.g., the second user) may view and/or control more parameters via more UI templates within the automatically generated UI than the nurse.

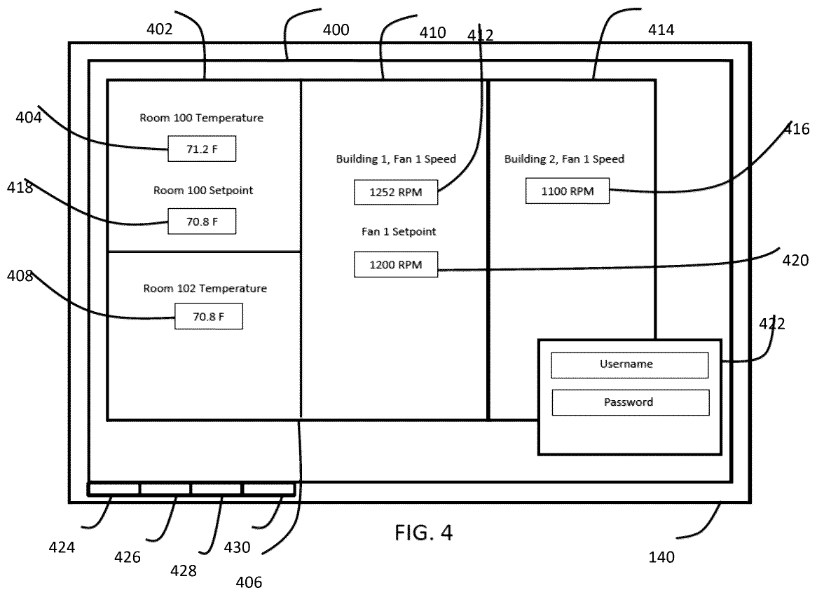

FIG. 4 shows an example of a UI 400 that may be automatically generated for a particular user by the method 300 of FIG. 3 or another method. The UI 400 may be displayed at, for example, the display 140 of the building control system of FIG. 1 or another computing device. The UI 400 may include one or more windows or panels (e.g., panels). For example, the UI 400 includes a first panel 402 (e.g., corresponding to the first UI template) that displays a representation of a first type of data 404. The representation of the first type of data 404 may include one or more linked datapoints corresponding to the first type of data. For example, the one or more linked datapoints may include at least one datapoint of time series data for the first type of data. In other words, the representation of the first type of data 404 may include a most recently measured value of the first type of data. The displayed representation of the first type of data 404 may change when a new value for the second type of data is measured.

The first type of data may be any number of different types of data. For example, the first type of data may be a temperature within a first room of a first building (e.g., Room 100). In other embodiments, the first panel 402 may display additional and/or different types of data (e.g., pressure within Room 100). The representation of the first type of data 404 may include a most recently measured temperature within Room 100, for example.

In the embodiment shown, the UI 400 also includes a second panel 406 (e.g., corresponding to the second UI template) that displays a representation of a second type of data 408. The representation of the second type of data 408 may include one or more linked datapoints corresponding to the second type of data. For example, the one or more linked datapoints may include at least one datapoint of time series data for the second type of data. In other words, the representation of the second type of data 408 may include a most recently measured value of the second type of data. The displayed representation of the second type of data 408 may change when a new value for the second type of data is measured.

The second type of data may be any number of different types of data. For example, the second type of data may be a temperature within a second room of the first building (e.g., Room 102). In other embodiments, the second panel 406 may display additional and/or different types of data (e.g., pressure within Room 102). The representation of the second type of data 408 may include a most recently measured temperature within Room 102, for example.

In the embodiment shown, the UI 400 also includes a third panel 410 (e.g., corresponding to the fourth UI template) that displays a representation of a third type of data 412. The representation of the third type of data 412 may include one or more linked datapoints corresponding to the third type of data. For example, the one or more linked datapoints may include at least one datapoint of time series data for the third type of data. In other words, the representation of the third type of data 412 may include a most recently measured value of the third type of data. The displayed representation of the third type of data 412 may change when a new value for the third type of data is measured.

The third type of data may be any number of different types of data. For example, the third type of data may be a fan speed for a fan within the first building (e.g., Room 100). In other embodiments, the third panel 410 may display additional and/or different types of data (e.g., humidity within the first building). The representation of the third type of data 412 may include a most recently measured fan speed of the fan within the first building, for example.

In the embodiment shown, the UI 400 also includes a fourth panel 414 (e.g., corresponding to a fifth UI template of the plurality of UI templates) that displays a representation of a fourth type of data 416. The representation of the fourth type of data 416 may include one or more linked datapoints corresponding to the fourth type of data. For example, the one or more linked datapoints may include at least one datapoint of time series data for the fourth type of data. In other words, the representation of the fourth type of data 416 may include a most recently measured value of the fourth type of data. The displayed representation of the fourth type of data 416 may change when a new value for the third type of data is measured.

The fourth type of data may be any number of different types of data. For example, the fourth type of data may be a fan speed for a fan within a second building. In other embodiments, the fourth panel 414 may display additional and/or different types of data (e.g., humidity within the second building). The representation of the fourth type of data 416 may include a most recently measured fan speed of the fan within the second building, for example.

The permission matrix, for example, may define which types of data are editable by the user. For example, the permission matrix may identify the first type of data (e.g., the temperature within Room 100) and the third type of data (e.g., the fan speed of the fan within the first building) as being editable by the user. Accordingly, the first panel 402 and the third panel 410 may include respective interfaces 418, 420 for changing parameters corresponding to the first type of data and the third type of data, respectively.

The interfaces 418, 420 in the example shown in FIG. 4 shows text boxes into which the user may enter target setpoints. The interfaces 418, 420 may be configured differently in other embodiments. For example, the interfaces 418, 420 may each include a “+” button and a “−” button to increase and decrease, respectively, the target setpoints by predetermined amounts. In another embodiment, the interfaces 418, 420 may include slider interfaces for adjustment of the target setpoints, respectively.

In the embodiment shown in FIG. 4, the user does not have authorization (e.g., as defined by the permission matrix) to change the setpoints for the second type of data (e.g., at the second panel 406) or the fourth type of data (e.g., at the fourth panel 414). Accordingly, the user is only able to view current values for the second type of data and the fourth type of data, respectively.

The UI 400 may also include a login window 422 in which identification information (e.g., a username and/or a password) may be entered by, for example, the user with one or more input devices (e.g., a mouse and a keyboard) at the workstation. The UI 400 may include more, fewer, and/or different windows, tabs, buttons, and/or other interfaces.

For example, the UI 400 may include a number of tabs corresponding to a number of different pages within the UI 400, respectively. In the example of FIG. 4, a page corresponding to a first tab 424 is shown. The first tab 424 may correspond to the automatically generated UI (e.g., “My Dashboard”; generated with the method 300 of FIG. 3 or another method). A second tab 426 may correspond to insights for the automatically generated UI shown at the first tab 424. For example, information about controllers and/or equipment that is monitored and/or controlled at the first tab 424 may be displayed within the second tab 426. A third tab 428 may correspond to building insights. For example, information about buildings within which the controllers and/or the equipment that is monitored and/or controlled is located may be displayed within the third tab 428. A fourth tab 430 may include recommendations for additional UI templates to be displayed. For example, when a predetermined number of users with a particular role or a predetermined percentage of users with a particular role add a UI template (e.g., a frequently added UI template) to be displayed (e.g., at the first tab 424), the frequently added UI template may be pushed to all users with the particular role. The fourth tab 430 may identify and/or show such frequently requested UI templates. Additional, fewer, and/or different tabs may be presented to the user within the UI 400.

The user may add UI templates (e.g., panels) to or remove UI templates from the automatically generated UI 400 shown in FIG. 4. For example, the user may add UI templates (e.g., the third UI template) defined as available to the user (e.g., defined as addable) within the permission matrix. The user may interface with the automatically generated UI 400 to move and/or size the panels (e.g., the first panel 402, the second panel 406, the third panel 410, and/or the fourth panel 414) within the UI 400. Such positioning and/or sizing customization may be saved (e.g., locally at the workstation) and applied the next time the user logs in to access the UI 400.

Listed below are various illustrative Embodiments. The Illustrative Embodiments summarize different combinations of aspects. Other combinations of any of the aspects with any other one or more of the aspects may be provided. Aspects from one type (e.g., method or system) may be used in another type (system or method).

Illustrative Embodiment 1. A method for automatically configuring a user interface (UI) for a user of a building management system for an enterprise, the method comprising: providing a plurality of UI templates, each UI template of the plurality of UI templates being linked to at least one type of data; storing, by a memory, a plurality of datapoints generated by the building management system, each datapoint of the plurality of datapoints generated by the building management system corresponding to a respective one of the types of data and being linked to at least one UI template of the plurality of UI templates; receiving, by a processor, user identification data for the user; identifying, by the processor, a role associated with the user based on the received user identification data, the role being specific to a function of the enterprise; identifying, by the processor, a subset of UI templates of the plurality of UI templates based on the identified role associated with the user; and displaying, by a display, the identified subset of UI templates as the UI and the datapoints linked to the identified subset of UI templates, respectively.

Illustrative Embodiment 2. The method of Illustrative Embodiment 1, wherein the memory is a memory of one or more cloud servers, and the processor is a processor of the one or more cloud servers, and wherein the display is a display of a workstation of the building management system.

Illustrative Embodiment 3. The method of any of Illustrative Embodiments 1-2, wherein storing, by the memory, the plurality of datapoints generated by the building management system comprises: generating, by one or more controllers and equipment located within one or more buildings of the enterprise that are controlled by the building management system, the plurality of datapoints being related to operations of the one or more buildings; transmitting, via a network, the plurality of datapoints to the one or more cloud servers; and storing, by the memory, the transmitted plurality of datapoints

Illustrative Embodiment 4. The method of any of Illustrative Embodiments 1-3, wherein identifying the role associated with the user comprises: comparing the received identification data associated with the user to a permission matrix; and identifying the role associated with the user based on the comparing

Illustrative Embodiment 5. The method of any of Illustrative Embodiments 1-4, wherein the permission matrix defines a plurality of users, a role for each user of the plurality of users, and one or more descriptions of one or more types of data to be presented to the respective user, the plurality of users including the user.

Illustrative Embodiment 6. The method of any of Illustrative Embodiments 1-5, wherein the permission matrix further defines, for each user of the plurality of users, which of the one or more types of data is changeable by the respective user, ranges within which the respective type of data is changeable, or a combination thereof.

Illustrative Embodiment 7. The method of any of Illustrative Embodiments 1-6, wherein receiving the identification data associated with the user comprises receiving a username, a password, or the username and the password at the workstation of the building management system.

Illustrative Embodiment 8. The method of any of Illustrative Embodiments 1-7, wherein the user is a first user, the role is a first role, and the subset of UI templates is a first subset of UI templates, and wherein the method further comprises: configuring the UI for a second user of the building management system, the configuring of the UI for the second user comprising: identifying, by the processor, a second role associated with the second user, the second user being different than the first user and the second role being different than the first role; identifying, by the processor, a second subset of UI templates of the plurality of UI templates based on the identified second role associated with the second user, the second subset of UI templates being different than the first subset of UI templates; and displaying, by the display, the identified second subset of UI templates as the UI and the datapoints linked to the identified second subset of UI templates, respectively.

Illustrative Embodiment 9. The method of any of Illustrative Embodiments 1-8, wherein the first role is a nurse, and the second role is a building engineer.

Illustrative Embodiment 10. The method of any of Illustrative Embodiments 1-9, wherein the first subset of UI templates includes fewer UI templates of the plurality of UI templates than the second subset of UI templates includes.

Illustrative Embodiment 11. The method of any of illustrative Embodiments 1-10, wherein the processor is a first processor, and wherein the method further comprises: receiving, by a second processor, a request for a custom UI template from the user, the second processor being a processor of the workstation of the building management system, wherein the custom UI template is linked to at least one other type of data; generating the custom UI template based on the received request; and adding the generated custom UI template to the UI, such that the identified subset of UI templates and the generated custom UI template are displayed as the UI.

Illustrative Embodiment 12. The method of any of illustrative Embodiments 1-11, further comprising editing the permission matrix, such that, for the user, the one or more descriptions of the one or more types of data to be presented to the respective user includes the at least one other type of data.

Illustrative Embodiment 13. The method of any of illustrative Embodiments 1-12, further comprising: receiving a request for the custom UI template from a subset of users of the plurality of users, the subset of users all having the role and including the user; and when the number of users of the subset of users is greater than a predetermined number of users: editing the permission matrix such that, for all users of the plurality of users having the role, the one or more descriptions of the one or more types of data to be presented to the respective user includes the at least one other type of data.

Illustrative Embodiment 14. The method of any of illustrative Embodiments 1-13, wherein the types of data comprise temperature data for a first room within the one or more buildings of the enterprise, pressure data for a second room within the one or more buildings of the enterprise, and fan speed data for at least one fan associated with the one or more buildings of the enterprise.

Illustrative Embodiment 15. A system for automatically configuring a user interface (UI) for a user of a building management system for an enterprise, the system comprising: a database comprising: a plurality of UI templates, each UI template of the plurality of UI templates being linked to at least one type of data; and a plurality of datapoints generated by the building management system, each datapoint of the plurality of datapoints generated by the building management system corresponding to a respective one of the types of data and being linked to at least one UI template of the plurality of UI templates; a processor in communication with the database, the processor being configured to: identify a role associated with the user, the role being specific to a function of the enterprise; and identify a subset of UI templates of the plurality of UI templates based on the identified role associated with the user; and a display in communication with the processor, the display being configured to display the identified subset of UI templates as the UI and the datapoints linked to the identified subset of UI templates, respectively.

Illustrative Embodiment 16. The system of Illustrative Embodiment 15, wherein the database is a database of one or more cloud servers, and the processor is a processor of the one or more cloud servers, and wherein the display is a display of a workstation of the building management system.

Illustrative Embodiment 17. The system of any of illustrative Embodiments 15-16, wherein the processor is a first processor, and wherein the system further comprises: one or more controllers and equipment located within one or more buildings of an enterprise that are controlled by the building management system, one or more controllers and the equipment being configured to generate the plurality of datapoints, which are related to operations of the one or more buildings; and a second processor in communication with the first processor, the second processor being configured to transmit, via a network, the plurality of datapoints to the first processor, and wherein the database is configured to store the transmitted plurality of datapoints

Illustrative Embodiment 18. The system of any of illustrative Embodiments 15-17, wherein the database further comprises a permission matrix, and wherein the processor being configured to identify the role associated with the user comprises the processor being configured to: receive identification data associated with the user; compare the received identification data associated with the user to the permission matrix; and identify the role associated with the user based on the comparison.

Illustrative Embodiment 19. The system of any of illustrative Embodiments 15-18, wherein the permission matrix defines a plurality of users, a role for each user of the plurality of users, and one or more descriptions of one or more types of data to be presented to the respective user, the plurality of users including the user.

Illustrative Embodiment 20. A method for automatically configuring a user interface (UI) displayed at a workstation of a building management system for different users of the workstation of the building management system, the method comprising: providing a plurality of UI templates, each UI template of the plurality of UI templates being linked to at least one type of data; storing, by a memory, a plurality of datapoints generated by the building management system, each datapoint of the plurality of datapoints generated by the building management system corresponding to a respective one of the types of data and being linked to at least one UI template of the plurality of UI templates; identifying, by a processor, a first role associated with a first user at the workstation of the building management system, the first role being specific to a function of an enterprise for which the building management system is operated; identifying, by the processor, a first subset of UI templates of the plurality of UI templates based on the identified first role associated with the first user; displaying, by a display, the identified first subset of UI templates as the UI and the datapoints linked to the identified first subset of UI templates, respectively; identifying, by the processor, a second role associated with a second user at the workstation of the building management system, the second user being different than the first user and the second role being different than the first role; identifying, by the processor, a second subset of UI templates of the plurality of UI templates based on the identified second role associated with the second user, the second subset of UI templates being different than the first subset of UI templates; and reconfiguring the UI, the reconfiguring of the UI comprising displaying, by the display, the identified second subset of UI templates as the UI and the datapoints linked to the identified second subset of UI templates, respectively.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

1. A method for automatically configuring a user interface (UI) for a user of a building management system for an enterprise, the method comprising:
providing a plurality of UI templates, each UI template of the plurality of UI templates being linked to at least one type of data;
storing, by a memory, a plurality of datapoints generated by the building management system, each datapoint of the plurality of datapoints generated by the building management system corresponding to a respective one of the types of data and being linked to at least one UI template of the plurality of UI templates;
receiving, by a processor, user identification data for the user;
identifying, by the processor, a role associated with the user based on the received user identification data, the role being specific to a function of the enterprise;
identifying, by the processor, a subset of UI templates of the plurality of UI templates based on the identified role associated with the user; and
displaying, by a display, the identified subset of UI templates as the UI and the datapoints linked to the identified subset of UI templates, respectively.

2. The method of claim 1, wherein the memory is a memory of one or more cloud servers, and the processor is a processor of the one or more cloud servers, and
wherein the display is a display of a workstation of the building management system.

3. The method of claim 2, wherein storing, by the memory, the plurality of datapoints generated by the building management system comprises:
generating, by one or more controllers and equipment located within one or more buildings of the enterprise that are controlled by the building management system, the plurality of datapoints being related to operations of the one or more buildings;
transmitting, via a network, the plurality of datapoints to the one or more cloud servers; and
storing, by the memory, the transmitted plurality of datapoints.

4. The method of claim 2, wherein identifying the role associated with the user comprises:
comparing the received identification data associated with the user to a permission matrix; and
identifying the role associated with the user based on the comparing.

5. The method of claim 4, wherein the permission matrix defines a plurality of users, a role for each user of the plurality of users, and one or more descriptions of one or more types of data to be presented to the respective user, the plurality of users including the user.

6. The method of claim 5, wherein the permission matrix further defines, for each user of the plurality of users, which of the one or more types of data is changeable by the respective user, ranges within which the respective type of data is changeable, or a combination thereof.

7. The method of claim 4, wherein receiving the identification data associated with the user comprises receiving a username, a password, or the username and the password at the workstation of the building management system.

8. The method of claim 4, wherein the user is a first user, the role is a first role, and the subset of UI templates is a first subset of UI templates, and
wherein the method further comprises:
configuring the UI for a second user of the building management system, the configuring of the UI for the second user comprising:
identifying, by the processor, a second role associated with the second user, the second user being different than the first user and the second role being different than the first role;
identifying, by the processor, a second subset of UI templates of the plurality of UI templates based on the identified second role associated with the second user, the second subset of UI templates being different than the first subset of UI templates; and
displaying, by the display, the identified second subset of UI templates as the UI and the datapoints linked to the identified second subset of UI templates, respectively.

9. The method of claim 8, wherein the first role is a nurse, and the second role is a building engineer.

10. The method of claim 9, wherein the first subset of UI templates includes fewer UI templates of the plurality of UI templates than the second subset of UI templates includes.

11. The method of claim 5, wherein the processor is a first processor, and
wherein the method further comprises:
receiving, by a second processor, a request for a custom UI template from the user, the second processor being a processor of the workstation of the building management system, wherein the custom UI template is linked to at least one other type of data;
generating the custom UI template based on the received request; and
adding the generated custom UI template to the UI, such that the identified subset of UI templates and the generated custom UI template are displayed as the UI.

12. The method of claim 11, further comprising editing the permission matrix, such that, for the user, the one or more descriptions of the one or more types of data to be presented to the respective user includes the at least one other type of data.

13. The method of claim 12, further comprising:
receiving a request for the custom UI template from a subset of users of the plurality of users, the subset of users all having the role and including the user; and
when the number of users of the subset of users is greater than a predetermined number of users:
editing the permission matrix such that, for all users of the plurality of users having the role, the one or more descriptions of the one or more types of data to be presented to the respective user includes the at least one other type of data.

14. The method of claim 2, wherein the types of data comprise temperature data for a first room within the one or more buildings of the enterprise, pressure data for a second room within the one or more buildings of the enterprise, and fan speed data for at least one fan associated with the one or more buildings of the enterprise.

15. A system for automatically configuring a user interface (UI) for a user of a building management system for an enterprise, the system comprising:
a database comprising:
a plurality of UI templates, each UI template of the plurality of UI templates being linked to at least one type of data; and
a plurality of datapoints generated by the building management system, each datapoint of the plurality of datapoints generated by the building management system corresponding to a respective one of the types of data and being linked to at least one UI template of the plurality of UI templates;
a processor in communication with the database, the processor being configured to: identify a role associated with the user, the role being specific to a function of the enterprise; and
identify a subset of UI templates of the plurality of UI templates based on the identified role associated with the user; and
a display in communication with the processor, the display being configured to display the identified subset of UI templates as the UI and the datapoints linked to the identified subset of UI templates, respectively.

16. The system of claim 15, wherein the database is a database of one or more cloud servers, and the processor is a processor of the one or more cloud servers, and
wherein the display is a display of a workstation of the building management system.

17. The system of claim 16, wherein the processor is a first processor,
wherein the system further comprises:
one or more controllers and equipment located within one or more buildings of an enterprise that are controlled by the building management system, the one or more controllers and the equipment being configured to generate the plurality of datapoints, which are related to operations of the one or more buildings; and
a second processor in communication with the first processor, the second processor being configured to transmit, via a network, the plurality of datapoints to the first processor, and
wherein the database is configured to store the transmitted plurality of datapoints.

18. The system of claim 16, wherein the database further comprises a permission matrix, and
wherein the processor being configured to identify the role associated with the user comprises the processor being configured to:
receive identification data associated with the user;
compare the received identification data associated with the user to the permission matrix; and
identify the role associated with the user based on the comparison.

19. The system of claim 18, wherein the permission matrix defines a plurality of users, a role for each user of the plurality of users, and one or more descriptions of one or more types of data to be presented to the respective user, the plurality of users including the user.

20. A method for automatically configuring a user interface (UI) displayed at a workstation of a building management system for different users of the workstation of the building management system, the method comprising:
providing a plurality of UI templates, each UI template of the plurality of UI templates being linked to at least one type of data;
storing, by a memory, a plurality of datapoints generated by the building management system, each datapoint of the plurality of datapoints generated by the building management system corresponding to a respective one of the types of data and being linked to at least one UI template of the plurality of UI templates;
identifying, by a processor, a first role associated with a first user at the workstation of the building management system, the first role being specific to a function of an enterprise for which the building management system is operated;
identifying, by the processor, a first subset of UI templates of the plurality of UI templates based on the identified first role associated with the first user;
displaying, by a display, the identified first subset of UI templates as the UI and the datapoints linked to the identified first subset of UI templates, respectively;
identifying, by the processor, a second role associated with a second user at the workstation of the building management system, the second user being different than the first user and the second role being different than the first role;
identifying, by the processor, a second subset of UI templates of the plurality of UI templates based on the identified second role associated with the second user, the second subset of UI templates being different than the first subset of UI templates; and
reconfiguring the UI, the reconfiguring of the UI comprising displaying, by the display, the identified second subset of UI templates as the UI and the datapoints linked to the identified second subset of UI templates, respectively.
